(19) United States
(12) Patent Application Publication
(10) Pub. No.: US 2023/0193419 A1
(43) Pub. Date: Jun. 22, 2023

(54) LITHIUM OR MAGNESIUM EXTRACTION PROCESSES

(71) Applicant: Winner Water Services, Sharon, PA (US)

(72) Inventors: Bruce F. Monzyk, Town Creek, AL (US); Todd J. Beers, DuBois, PA (US)

(21) Appl. No.: 17/925,536

(22) PCT Filed: May 14, 2021
(86) PCT No.: PCT/US2021/032498

§ 371 Date: Nov. 15, 2022

Related U.S. Application Data
(60) Provisional application No. 63/025,480, filed on May 15, 2020.

(51) Int. Cl. C22B 3/30; C22B 26/12

(52) U.S. Cl. CPC C22B 3/30; C22B 26/12

(57) ABSTRACT

Systems and methods for removing lithium and/or magnesium from an aqueous solution are disclosed. The aqueous solution is extracted using an organic phase composition that comprises a hydroxamic acid, desirably an N-alkyl alkanohydroxamic acid having at least 9 carbon atoms. The extraction is performed at least twice, each time at a different pH. The first extraction is performed at an acidic pH and removes metal ions that otherwise interfere with lithium extraction. The second extraction is performed at a higher pH than the first extraction, and results in captured lithium and/or magnesium, and an aqueous salt solution.

### CROSS-REFERENCE TO RELATED APPLICATIONS

This application claims priority to U.S. Provisional Patent Application Ser. No. 63/025,480, filed on May 15, 2020, which is incorporated by reference in its entirety.

### BACKGROUND

The present disclosure relates to systems and methods for removing lithium, magnesium, and/or calcium metal ions from an aqueous solution, such as wastewater, aqueous brine, produced water, or flowback water.

Flowback water (aka backflow water or FBW) is the aqueous solution which is recovered during a hydraulic fracturing process for extracting oil or gas. The aqueous solution consists of fracturing fluids injected into the ground which returns to the surface along with produced water (naturally occurring water found underground and released by the fracturing process). Flowback water may be characterized as having high salinity and total dissolved solids (TDS). It contains chemicals that were pumped into the well, and any contaminants that may be present in the rock formation water which may be present deep below. In particular, flowback water usually contains lithium in small concentrations of about 50 ppm to about 300 ppm Li, 25-1,200 ppm Mg, and/or 2,000-10,000 ppm Ca. It would be desirable to be able to recover the lithium, magnesium, and/or calcium from such flowback water as well as other aqueous and wastewater sources such as produced water, and minewater.

### BRIEF DESCRIPTION

The present disclosure relates to methods for removing lithium (in ionic or elemental form or other forms) from a primary aqueous solution including water. Very generally, the water source may be a natural source, or the water could be pre-treated water, wastewater, or flowback water. However, it is particularly contemplated that the water source is produced wastewater from oil or gas wells (i.e. brine water) or mine drainage water or other mine-affected water.

In this regard, in some aspects disclosed herein, the water is extracted using an organic phase composition that comprises a hydroxamic acid. A dual extraction is performed twice, each time at a different pH. The first extraction is performed at an acidic pH and removes other metal ions that otherwise interfere with lithium extraction. The second extraction is performed at a higher pH than the first extraction, and results in captured lithium, magnesium, or calcium, and separately an aqueous salt solution.

Also disclosed in various embodiments are methods for separating lithium from a primary aqueous solution, comprising: (A) contacting the primary aqueous solution with an initial organic phase composition in a primary extraction stage to form a first mixture, wherein the initial organic phase composition comprises a hydroxamic acid; (B) separating the first mixture to obtain a metal-reduced raffinate and a metal-containing organic phase; (C) contacting the metal-reduced raffinate with a secondary organic phase composition in a secondary extraction stage to form a second mixture, wherein the secondary organic phase composition comprises a hydroxamic acid; (D) adjusting the pH of the metal-reduced raffinate or second mixture upwards to a pH of about 5 to about 12 and maintaining it within this pH range; while (E) separating the secondary mixture to obtain a lithium-depleted raffinate and a lithium-containing organic phase; and (F) stripping the lithium-containing organic phase with an acidic aqueous solution to obtain the lithium in a lithium-containing aqueous solution. If desired, magnesium or calcium can be the target of the separation process, instead of the lithium.

The primary extraction stage may be operated at an organic:aqueous ratio (v/v) of about 1:10 to about 10:1.

The metal-containing organic phase may comprise Al or Fe ions and lower concentrations of Ga, Co, Ni, Zn, Pb, Mg, and the like, originally present in the primary aqueous solution.

In particular embodiments, the primary aqueous solution has a pH of about 3 to about 8, and wherein the metal-reduced raffinate has a pH of about 3 to about 5.

The primary extraction stage may be in the form of a first set of liquid-liquid extractors arranged for counter-current flow. The first set may comprise 1 to about 7 liquid-liquid extractors.

In some embodiments, the method further comprises stripping the metal-containing organic phase to obtain a first aqueous product containing metal salts. The metal-containing organic phase may be stripped with HCl, acetic acid (HOAc), CO₂, H₂SO₄, or stabilized HNO₃, carbonic acid, phosphoric acid, bisulfate, tartaric acid, oxalic acid, citric acid, or a combination thereof. The metal-containing organic phase may be stripped in a primary stripping circuit comprising a set of liquid-liquid extractors arranged for counter-current or cross-current flow. The primary stripping circuit may comprise 1 to about 7 liquid-liquid extractors.

The pH of the metal-reduced raffinate may be adjusted using a base (during a second metal extraction circuit). The base can be any suitable base, such as Ca(OH)₂, Mg(OH)₂, Zn(OH)₂, NaOH, KOH, Na₂CO₃, K₂CO₃, Na₃PO₄, K₃PO₄, NH₃ (gas or aqueous), and pH-basic amines.

The secondary extraction stage may be in the form of a second set of liquid-liquid extractors arranged for counter-current flow or cross-current flow. The second set may comprise 1 to about 7 liquid-liquid extractors. The secondary extraction stage may be operated at an organic-to-aqueous ratio (v/v) (or E/A) of about 1:10 to about 10:1.

In particular embodiments, the lithium-depleted raffinate comprises Na⁺, Ca²⁺, or K⁺ ions. The lithium-depleted raffinate may have a pH of about 7 to about 10, more preferably about 8 to about 10, and most preferably about 8.5 to about 9.5.

The acidic aqueous solution used to strip the lithium-containing organic phase may comprise HCl, acetic acid (HOAc), CO₂, aqueous carbonic acid (H₂CO_{3(aq)}), H₂SO₄, or HNO₃, carbonic acid, phosphoric acid, bisulfate, tartaric acid, oxalic acid, citric acid, or a combination thereof. The lithium-containing organic phase may be stripped in a secondary stripping circuit comprising a set of liquid-liquid extractors arranged for counter-current flow or cross-current flow. The secondary stripping circuit may comprise 1 to about 7 liquid-liquid extractors. The lithium-containing aqueous solution may further contain Mg²⁺ ions using CO₃^{═} to strip Mg(OH)₂ and/or CaCO₃(s) crystals.

In specific embodiments, the hydroxamic acid used for the organic phase extraction is N-isopropyl-n-decyl-hydroxyamic acid, or N-isopropyl-n-nonanohydroxamic acid, or N-ethyl-n-nonanohydroxamic acid, or N-methyl decanohydroxamic acid, or N-alkyl (2-ethyl n-hexano)hydroxylamine acid.

The initial organic phase composition may comprise the hydroxamic acid, an organic solvent, and optionally an alcohol modifier. In some particular embodiments, the initial organic phase composition comprises about 2 to about 75 vol % of the hydroxamic acid, about 5 to about 97 vol % of the organic solvent, and about 1 to about 30 vol % of the alcohol modifier.

Also disclosed herein in various embodiments is a dual-extraction system, comprising: (A) a primary extraction stage adapted to receive a primary aqueous solution and an initial organic phase composition, and to produce a metal-reduced raffinate and a metal-containing organic phase; (B) a mixer adapted to adjust the pH of the metal-reduced raffinate upwards; (C) a secondary extraction stage adapted to receive the metal-reduced raffinate and a secondary organic phase composition, and to produce a lithium-depleted raffinate and a lithium-containing organic phase; and (D) a secondary stripping stage adapted to receive the lithium-containing organic phase and an acidic aqueous solution, and to produce a lithium-containing aqueous solution.

The dual-extraction system may further comprise a primary stripping stage adapted to receive the metal-containing organic phase from the primary extraction stage, and to produce a first aqueous product containing Al and Fe salts. In yet further embodiments, the dual-extraction system may also further comprise a primary wash stage adapted to receive a metal-stripped organic phase from the primary stripping stage and return a washed primary organic phase for reuse in the primary extraction stage.

The dual-extraction system can also further comprise a secondary wash stage adapted to receive a lithium-stripped organic phase from the secondary stripping stage and return a washed secondary organic phase for reuse in the secondary extraction stage.

Also alternatively disclosed herein in various embodiments is a dual-extraction system, comprising: (A) a primary extraction stage with an aqueous phase inlet, an organic phase inlet, an aqueous phase outlet, and an organic phase outlet; (B) a mixer fluidly connected to the aqueous phase outlet of the primary extraction stage and adapted to adjust the pH of fluid exiting the aqueous phase outlet; (C) a secondary extraction stage with an aqueous phase inlet, an organic phase inlet, an aqueous phase outlet, and an organic phase outlet, wherein the aqueous phase inlet of the secondary extraction stage is fluidly connected to the mixer; and (D) a secondary stripping stage with an organic phase inlet and an aqueous phase outlet, wherein the organic phase outlet of the secondary extraction stage is fluidly connected to the organic phase inlet of the secondary stripping stage.

The dual-extraction system may further comprise: (i) a feed tank fluidly connected to the aqueous phase inlet of the primary extraction stage; (ii) a primary extractant tank fluidly connected to the organic phase inlet of the primary extraction stage; and/or (iii) a secondary extractant tank fluidly connected to the organic phase inlet of the secondary extraction stage.

The dual-extraction system may also further comprise: (iv) a primary stripping stage with an organic phase inlet and an aqueous phase outlet, wherein the organic phase outlet of the primary extraction stage is fluidly connected to the organic phase inlet of the primary stripping stage; (v) a first aqueous product tank fluidly connected to the aqueous phase outlet of the primary stripping stage; (vi) a second aqueous product tank fluidly connected to the aqueous phase outlet of the secondary stripping stage; and/or (vii) a third aqueous product tank fluidly connected to the aqueous phase outlet of the secondary extraction stage.

The dual-extraction system may also further comprise: (viii) a primary wash stage with an aqueous phase inlet, an organic phase inlet, an aqueous phase outlet, and an organic phase outlet, wherein the organic phase outlet of the primary stripping stage is fluidly connected to the organic phase inlet of the primary wash stage.

The dual-extraction system can also further comprise: (ix) a secondary wash stage with an aqueous phase inlet, an organic phase inlet, an aqueous phase outlet, and an organic phase outlet, wherein the organic phase outlet of the secondary stripping stage is fluidly connected to the organic phase inlet of the secondary wash stage.

Also disclosed herein is a first aqueous product containing Al and Fe salts. The first aqueous product may have a pH of about 3 to about 6. The first aqueous product can also further comprise copper, nickel, cobalt, zinc, and/or manganese salts and the like.

Also disclosed is a second aqueous product containing lithium. The second aqueous product may have a combined lithium, magnesium, and calcium concentration of about 11,000 ppm, or higher. The second aqueous product may further comprise a purified magnesium solid, for example a solid form of carbonate and/or hydroxide, or obtained by calcining. The second aqueous product may further comprise barium (Ba) and strontium (Sr) in forms such as solid products, like sulfate and carbonate.

Also disclosed is a third aqueous brine product containing sodium, potassium, and/or optionally calcium. The third aqueous product may contain less than 300 ppm of lithium, or less than 50 ppm of lithium.

These and other non-limiting characteristics of the disclosure are more particularly disclosed below.

### BRIEF DESCRIPTION OF THE DRAWINGS

The following is a brief description of the drawing, which is presented for the purposes of illustrating the exemplary embodiments disclosed herein and not for the purposes of limiting the same.

FIG. 1 is a process diagram illustrating one system and method of the present disclosure. In this diagram, the Extraction B is performed using counter-current flow in the secondary stripping stage.

FIG. 2A is a process diagram illustrating another system and method of the present disclosure. In this diagram, the Extraction B is performed using cross-current flow in the secondary stripping stage.

FIG. 2B is another process diagram, showing a second embodiment of cross-current flow in the secondary stripping stage.

FIG. 3 is a process diagram illustrating a first test apparatus used in the examples. This apparatus was similar to the Extraction A stage of FIG. 1.

FIG. 4 is a process diagram illustrating a second test apparatus used in the examples. This apparatus was similar to the Extraction B stage of FIG. 1.

FIG. 5 is a process diagram illustrating a third test apparatus used in the examples. This apparatus was similar to the Extraction B stage of FIG. 4.

### DETAILED DESCRIPTION

A more complete understanding of the components, processes and apparatuses disclosed herein can be obtained by reference to the accompanying drawing. This figure is merely a schematic representation based on convenience and the ease of demonstrating the present disclosure, and is, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named components/steps and permit the presence of other components/steps. However, such description should be construed as also describing compositions or processes as “consisting of” and “consisting essentially of” the enumerated components/steps, which allows the presence of only the named components/steps, along with any impurities that might result therefrom, and excludes other components/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values).

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

The present disclosure refers to pH values. When a first pH value is “higher” than a second pH value, this means the first pH value has a numerically greater value compared to the second pH value, or is more basic. When a first pH value is “lower” than a second pH value, this means the first pH value has a numerically smaller value compared to the second pH value, or is more acidic. If the pH is adjusted “upwards”, the final pH value is higher than the original pH value, i.e. is more basic.

The present application refers to lithium. This term is intended to refer to lithium in its ionic form (Li⁺) or in the form of a salt or its elemental form.

The present application refers to magnesium. This term is intended to refer to magnesium in its ionic form (Mg²⁺) or in the form of a salt or its elemental form.

The present application refers to calcium. This term is intended to refer to calcium in its ionic form (Ca²⁺) or in the form of a salt or its elemental form.

The terms “inlet” and “outlet” are relative to a fluid flowing through them with respect to a given component, e.g. a fluid flows through the inlet into the component and flows through the outlet out of the component.

The terms “upstream” and “downstream” are relative to the direction in which a fluid flows through various components, i.e. the fluids flow through an upstream component prior to flowing through a downstream component. It should be noted that in a loop, a first component can be described as being both upstream of and downstream of a second component.

The present application refers to extraction stages, stripping stages, and wash stages, each of which is made up of one or more liquid-liquid extractors. Each such stage and each such extractor should be considered to have an aqueous phase inlet, an organic phase inlet, an aqueous phase outlet, and an organic phase outlet, as is known in the art and as is further discussed herein.

When the term “fluidly connected” is used to refer to two components, this means that the two components are joined together, either directly or indirectly, such that fluid can flow from one component to the other component.

The challenge with removing lithium (Li) from fluid streams containing high total dissolved solids (TDS) is that the Li concentration is usually very low (about 50 to about 300 ppm) when compared to the 80,000-300,000 ppm TDS in the fluid stream. As a result, many technologies do not work for several reasons such as lack of chemical selectivity due to interferences, extremely low production rates, or high capital and operating costs. Examples of such unworkable technologies include electroplating, ion exchange resins, selective precipitation, distillation, pyrometallurgical separation, electro-deionization separation, and co-crystallization separation.

The present disclosure relates to systems and methods for removing lithium and/or magnesium and/or calcium ions from a primary aqueous solution. Again, the primary aqueous solution is contemplated to be flowback water or mine drainage water, but can be from any water source. Very briefly, at least two extractions are performed at different pHs using an organic phase containing a hydroxamic acid. The first extraction is performed at an acidic pH and removes other metals that might otherwise contaminate the lithium/magnesium/calcium. The second extraction is performed at a higher pH (i.e. more basic than the first extraction) and separates the lithium and/or magnesium from the primary aqueous solution. The lithium is then stripped to obtain a concentrated solution of lithium and/or magnesium and/or calcium. The remaining aqueous solution is an aqueous salt solution. The metals removed by the first extraction can also be recovered. The system uses two liquid-liquid extraction (LLX) circuits. The systems and methods are generally operated at atmospheric pressure and at a temperature range of about 15° C. to about 55° C. (59° F. to 131° F.).

The LLX circuits used herein have several advantages. LLX has low energy requirements, avoids waste, has a low cost of operation and low cost for materials and construction, and has a fast development and deployment time.

The extractant used in the systems and methods of the present disclosure is an organic phase composition comprising a hydroxamic acid, an optional alcohol modifier, and an organic solvent (also known as a diluent).

The hydroxamic acid has the structure of Formula (I):

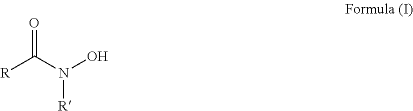

wherein R and R′ are independently alkyl or alkylaryl. Desirably, the hydroxamic acid is an N-alkyl alkanohydroxamic acid.

The term “alkyl” refers to a radical composed entirely of carbon atoms and hydrogen atoms which is fully saturated. The alkyl radical may be linear, branched, or cyclic. The alkyl radical has the ability to form a single bond to one or two different non-hydrogen atoms, depending on the context. For example, the formulas —CH₂—CH₃ and —CH₂—CH₂— should both be considered alkyl. As used herein, an alkyl group has from 1 to about 24 carbon atoms.

The term “alkylaryl” refers to a radical composed of an alkyl radical that is bonded to an aryl radical. The aryl radical is an aromatic radical composed entirely of carbon atoms, and hydrogen atoms along the perimeter of the radical. The aromatic radical can take any shape. For example, the aromatic radical can be a planar radical such as phenyl or napthyl, or can be three-dimensional such as fullerene (e.g. CH) or a carbon nanotube. When aryl is described in connection with a numerical range of carbon atoms, it should not be construed as including substituted aromatic radicals. For example, the phrase “aryl containing from 6 to 10 carbon atoms” should be construed as referring to a phenyl group (6 carbon atoms) or a naphthyl group (10 carbon atoms) only, and should not be construed as including a methylphenyl group (7 carbon atoms). As used herein, the aryl radical has from 6 to about 120 carbon atoms, and in narrower embodiments has from 6 to about 10 carbon atoms. The aryl radical is covalently bonded to the alkyl radical, such that the R or R′ radical of Formula (I) is joined to the carbonyl atom or the nitrogen atom through the alkyl radical. Examples of alkylaryl radicals include —CH₂—C₆H₅ and —CH₂CH₂—C₆H₅. The aryl radical of the alkylaryl radical should not be bonded to the N atom or to the carbonyl group directly or by resonance through the aryl ring, because this would generate resonance stabilization bonds which would cause the compound to be readily degraded through hydrolysis, oxidation, and/or rearrangement.

In particular embodiments, both R and R′ are linear or branched alkyl groups, and in more specific embodiments R and R′ are alkyl groups of different lengths. In more specific embodiments, R contains 3 to about 18 carbon atoms, and R′ contains from 1 to about 6 carbon atoms. R and R′ are selected to impart desired chelation selectivity to extract certain metal ions, or to avoid extraction of certain metal ions.

In particular embodiments, the hydroxamic acid is N-isopropyl-n-decano-hydroxamic acid (aka N-isopropyl n-undecanoic hydroxylamine), or N-isopropyl-n-nonanohydroxamic acid (aka N-isopropyl-n-decanohydroxylamine), or N-ethyl-n-nonanohydroxamic acid (aka N-isopropyl-n-decanohydroxylamine). The hydroxamic acid may have a total carbon number of 10 to 34. The hydroxamic acid may be present in the amount of about 1 to about 75 vol % of the organic phase composition, or about 2 to about 70 vol %, or about 17 vol % to about 60 vol %, or about 5 to about 25 vol %, or about 2.5 vol % to about 17 vol %, or about 5 to about 45 vol %, or about 15 to about 35 vol %. Such hydroxamic acids (or salts thereof) are commercially available, or their synthesis procedures are available in the open literature.

The organic phase composition may also comprise an alcohol modifier. The alcohol may be decyl alcohol. The alcohol modifier may be present in the amount of about 1 to about 30 vol % of the organic phase composition, including from about 1 to about 10 vol %.

Finally, the organic phase composition also comprises an organic solvent that serves as a carrier for the hydroxamic acid. The organic solvent may be pure (i.e. a single liquid) or blended. Desirably, the organic solvent is nonflammable and has a low viscosity. The organic solvent may be an aliphatic molecule. Aliphatic hydrocarbons are preferred for their selectivity and low odor. Aromatic hydrocarbons alone or blended with aliphatics may also be acceptable from a performance perspective. Examples of suitable organic solvents can include kerosene, diesel fuel, JP4 jet fuel, tributyl phosphate (TBP)/kerosene, isoparaffinic fluids offered under the trade name ISOPAR, hydrocarbon fluids offered under the trade name NORPAR or Escaid™ 110 (CAS #64742-47-8) or Solvesso™ 100 (CAS #64742-95-6) or Solvesso™ 150 (CAS #64742-94-5), and the like. The organic solvent may be present in an amount that balances the formulation for the extractant. In particular embodiments, the amount of the organic solvent is from about 5 to about 97 vol % of the organic phase composition, including from about 65 vol % to about 75 vol %, or from about 70 vol % to about 95 vol %.

In particular embodiments, the extractant is an organic phase composition comprising the hydroxamic acid, the alcohol modifier, and the organic solvent, wherein the sum of these three ingredients is 100 vol % of the extractant. Some particular compositions comprise about 20 to about 30 vol % of the hydroxamic acid, about 1 to about 10 vol % of the alcohol modifier, and about 65 to about 75 vol % of the organic solvent. The alcohol modified can be entirely omitted as well if lithium extraction is desired, since lithium salts are soluble in alcohols and other oxygenated organic fluids, such as ethers, esters, and the like.

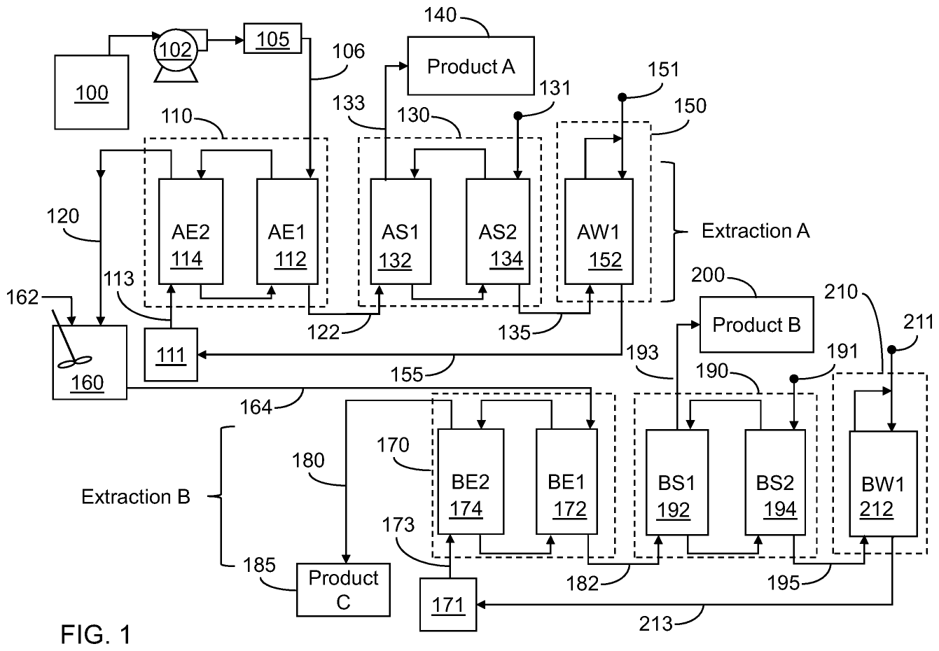

FIG. 1 is a process flow diagram illustrating the methods of the present disclosure as well as systems for carrying out the methods. It is contemplated that these methods can be used for continuous processing or for batch processing.

The process begins with a primary aqueous solution which is provided in tank 100. The primary aqueous solution contains lithium (Li), and usually also contains other metals such as aluminum (Al), iron (Fe), magnesium (Mg), and/or calcium (Ca), and potentially other metals and ions as discussed further herein.

The primary aqueous solution is pumped via pump 102 through a filter 105. The filter is intended to catch large particles such as rocks, stones, trash, and dirt, and prevent them from flowing through the system. The resulting clear feed solution exits the filter through line 106. At this point, the solution has a pH of about 3 to about 8 prior to the beginning of extraction, including a pH of about 3 to about 6. It is contemplated that the pH of the primary aqueous solution is adjusted to fall within this pH range prior to entering the primary extraction stage 110.

Primary Extraction

Next, the primary aqueous solution flows through line 106 and enters a primary extraction stage 110. The primary extraction stage is made up of at least one liquid-liquid extractor, and usually a set of such liquid-liquid extractors. As illustrated here, the primary extraction stage has two liquid-liquid extractors 112, 114. It is noted that generally any number of liquid-liquid extractors can be connected in series for the extraction. In particular embodiments, it is contemplated that the primary extraction stage 110 can comprise from 1 to about 7 liquid-liquid extractors. Examples of such extractors include extraction columns, mixer-settlers, hydrocyclones, and centrifuges. In experiments, 2 or 3 or 4 liquid-liquid extractors have been found to be sufficient for this extraction operation.

A primary extractant tank 111 feeds an initial organic phase composition to the primary extraction stage. The initial organic phase composition comprises the organic solvent/carrier, the hydroxamic acid, and the optional alcohol modifier.

The primary aqueous solution and the organic phase composition flow counter-current to each other through the primary extraction stage. As illustrated here, the organic phase composition is fed into extractor AE2 114 through line 113 and then flows into extractor AE1 112. The primary aqueous solution is fed into extractor AE1 112 and then flows into extractor AE2 114. The primary extraction stage is usually operated at an organic:aqueous ratio (v/v) of about 1:10 to about 10:1, including from about 1:5 to about 5:1. The residence time of the primary aqueous solution (during which the primary aqueous solution is mixed with the organic phase composition) may range from about 30 seconds to about 5 minutes, including from about 1 minute to about 4 minutes, in the primary extraction stage.

To maximize extraction of aluminum and iron (Al/Fe), it has been found that an organic:aqueous ratio (v/v) of about 1:10 to about 1:1 is more desirable, including from 1:5: to about 1:1 and from about 1:3 to about 1:1. It is also desirable to use more liquid-liquid extractors.

Within the primary extraction stage, the primary aqueous solution and the initial organic phase composition can be considered to form a first mixture. The first mixture is then separated to obtain a metal-reduced raffinate and a metal-containing organic phase. The metal-reduced raffinate exits the primary extraction stage through line 120, and the metal-containing organic phase exits the primary extraction stage through line 122.

The metal-reduced raffinate or metal depleted raffinate is an aqueous solution that contains lithium, and may also contain magnesium (Mg). Desirably, the amount and concentration of other metals, such as aluminum (Al) and iron (Fe), is reduced compared to the primary aqueous solution. It is noted that the pH of this aqueous solution automatically decreases (i.e. becomes more acidic without the addition of acid) during the primary extraction, and thus the raffinate has a lower pH than the feed. In particular embodiments, the resulting metal-reduced raffinate may have a pH of about 3 to about 5. Thus, acid is typically not added to the primary extraction stage (although base might be added to maintain the pH within this range) if additional metal extractions are desired, such as for Cu, Ni, Co, Zn, and the like.

The metal-containing organic phase contains metals such as aluminum (Al) and iron (Fe), in hydroxamate complex form. It is desirable to remove these metals from the aqueous solution so that they do not contaminate the lithium to be recovered in the next processing stage, and so they do not hinder the extraction of the lithium and/or Mg²⁺. This can also be considered an “Extraction A”.

Primary Stripping

The metal-containing organic phase enters a primary stripping circuit 130. The primary stripping circuit is made up of at least one liquid-liquid extractor, and usually a set of such liquid-liquid extractors. As illustrated here, the primary stripping circuit has two liquid-liquid extractors 132, 134. It is noted that generally any number of liquid-liquid extractors can be connected in series for the stripping process. In particular embodiments, it is contemplated that the primary stripping circuit 130 can comprise from 1 to about 7 liquid-liquid extractors, including from 1 to about 4 extractors.

A first aqueous stripping solution 131 is fed into the primary stripping circuit. The first aqueous stripping solution is acidic. In some particular embodiments, 6M HCl is used, although of course other concentrations can be used. Concentrations of 0.1M to 12M can be effective. Other acids can also be used, such as acetic acid (HOAc), CO₂, H₂SO₄, HNO₃, carbonic acid, phosphoric acid, bisulfate, tartaric acid, oxalic acid, citric acid, or a combination thereof. A stabilizer is typically used with the HNO₃ to prevent significant oxidation of the organic phase components. Such stabilizers can include hydroxylamine, urea, sulfite, and the like. Generally, the pH of the first aqueous stripping solution is about 3 or less.

As illustrated in FIG. 1, the first aqueous stripping solution and the metal-containing organic phase flow counter-current to each other through the primary stripping circuit. As illustrated here, the metal-containing organic phase is fed into extractor AS1 132 through line 122 and then flows into extractor AS2 134. The first aqueous stripping solution is fed into extractor AS2 134 and then flows into extractor AS2 132. The primary stripping circuit is usually operated at an organic:aqueous ratio (v/v) of about 1:10 to about 10:1, including from about 1:5 to about 5:1. The residence time of the metal-containing organic phase (during which the aqueous stripping solution and the metal-containing organic phase are mixed) may range from about 30 seconds to about 5 minutes, including from about 1 minute to about 4 minutes, in the primary stripping circuit.

The aqueous solution and the organic phase are then separated to obtain a first aqueous product and a metal-stripped organic phase. The metal-containing first aqueous product exits the primary stripping circuit through line 133, and the metal-stripped organic phase exits the primary stripping circuit through line 135. The first aqueous product will be an aqueous solution containing metal salts (typically Al and Fe salts). The pH of the first aqueous product will usually be from zero to about 4. The first aqueous product is then collected in tank 140. It is contemplated that this could be used as a water purification coagulant.

Primary Wash

The metal-stripped organic phase desirably now does not contain any metals. The metal-stripped organic phase is then sent to a primary wash stage 150, where the organic phase is washed of any remaining stripping acid.

The primary wash stage is made up of at least one liquid-liquid extractor, and usually a set of such liquid-liquid extractors. Only one liquid-liquid extractor 152 is illustrated. It is noted that generally any number of liquid-liquid extractors can be connected in series for the washing process. In particular embodiments, it is contemplated that the primary wash stage 150 can comprise from 1 to about 5 liquid-liquid extractors.

A first aqueous wash solution 151 is fed into the primary wash stage. The first aqueous wash solution can simply be water, such as deionized (DI) water, although of course minor concentrations of other ions can be present. The first aqueous wash solution can be slightly acidic, or may have a basic pH to reduce residual acidity in the organic phase. Basic reagents such as dilute solutions of bicarbonate ion, carbonate ion, hydroxide ion, magnesium acetate, sodium acetate, aqueous ammonia and alkyl amines, and the like may be present. Associated cations such as sodium, potassium, ammonium, and organic protonated amine can be present. Generally, the pH of the first aqueous wash solution is from about 3 to about 8.5, including from about 3 to about 7, or from about 7 to about 8.5.

The first aqueous wash solution and the metal-stripped organic phase flow counter-current to each other through the primary wash stage. The primary wash stage is usually operated at an organic:aqueous ratio (v/v) of about 1:10 to about 20:1, including from about 1:10 to about 10:1 or about 1:5 to about 5:1. The residence time of the metal-stripped organic phase (during which the aqueous wash solution and the metal-stripped organic phase are mixed) may range from about 30 seconds to about 5 minutes, including from about 1 minute to about 4 minutes or about 1 minute to about 3 minutes, in the primary wash stage.

The first aqueous wash solution and the resulting washed primary organic phase (which is free of metal ions) are then separated. This washed primary organic phase can be sent through wash recycle line 155 back to the initial extractant tank 111 to be used in the primary extraction stage. The first aqueous wash solution can be recycled through the primary wash stage, or can be reused, purged, processed for any concentrated values collected there, used to prepare the aqueous stripping solution, etc.

pH Adjustment

Referring back to the metal-reduced raffinate in line 120, the metal-reduced raffinate has a pH of about 3 to about 5. A base is added to adjust the pH of the metal-reduced raffinate upwards to a range of about 5 to about 12, and more desirably a pH of about 6.1 to about 12, or about 7 to about 10, or about 8 to about 9.5, or about 8 to about 10, or about 8 to about 12. For example, a pH range of about 7 to about 10 may be desired if it is desired to recover both Li and Mg, or a pH range of about 8 to about 9.5 may be used if it is desired only to recover Li. The base may be, for example, Ca(OH)₂, Mg(OH)₂, Zn(OH)₂, NaOH, CaO, MgO, ZnO, or KOH, or a dilute solution of bicarbonate ion, carbonate ion, hydroxide ion, magnesium acetate, sodium acetate, aqueous ammonia and alkyl amines, an ammonium compound (e.g. ammonium hydroxide), and the like. The base may be added in dry form, liquid form, or gaseous form (e.g. anhydrous ammonia gas) to the metal-reduced raffinate, preferably while stirring.

For illustrative purposes, the metal-reduced raffinate is depicted as flowing through line 120 into a mixer 160, which takes the form of a tank with an impeller and a pH meter. The base is identified as reference numeral 162. The pH-adjusted metal-reduced raffinate, still containing lithium (as well as potentially other metals/ions like Mg, Ca, Na, K, Ba, Sr, and the like), then exits the mixer through line 164 and is sent to the secondary extraction stage 170. However, mixer 160 is not necessary; for example, the pH adjustment could occur within pipes with internal vanes or other structures that encourage mixing and pH control. Alternatively, the pH adjustment could be done in the secondary extraction stage 170.

Secondary Extraction

The secondary extraction stage 170 is made up of at least one liquid-liquid extractor, and usually a set of such liquid-liquid extractors. As illustrated here, the secondary extraction stage has two liquid-liquid extractors 172, 174. It is noted that generally any number of liquid-liquid extractors can be connected in series for the second extraction. In particular embodiments, it is contemplated that the secondary extraction stage 170 can comprise from 1 to about 10 liquid-liquid extractors, or from 1 to 4 extractors, or from 3 to 5 extractors, or from 7 to 10 extractors.

A secondary organic phase composition is then fed to the secondary extraction stage. The secondary organic phase composition also comprises the organic solvent/carrier, the hydroxamic acid, and the optional alcohol modifier. It is noted that at the modified pH range of about 5 to about 12, the hydroxamic acid will now extract lithium from the metal-reduced raffinate (and potentially also magnesium). For optimum lithium selectivity, the pH of the metal-reduced raffinate entering extractor 172 via line 164 should be about 7 to about 10, including from about 8.0 to about 9.5, and preferably a pH of about 8.5 to about 9.5. The secondary organic phase can be fed, for example, from primary extractant tank 111 or, as illustrated here, from a secondary extractant tank 171.

The metal-reduced raffinate (now controlled at a more basic pH) and the organic phase composition flow counter-current to each other through the secondary extraction stage. As illustrated here, the organic phase composition is fed into extractor BE2 174 through line 173 and then flows into extractor BE1 172. The metal-reduced raffinate (which is an aqueous solution) is fed from line 120/mixer 160 into extractor BE1 172 and then flows into extractor BE2 174. The secondary extraction stage is usually operated at an organic:aqueous ratio (v/v) of about 1:10 to about 10:1, including from about 1:5 to about 5:1. The residence time of the aqueous solution (during which the aqueous solution and the organic phase composition are mixed) may range from about 30 seconds to about 5 minutes, including from about 1 minute to about 4 minutes, in the secondary extraction stage.

It has been learned that high distribution coefficients provide better selectivity for lithium extraction. The organic:aqueous ratio is desirably greater than 1:1, more preferably greater than 3:1, and more preferably at least 7:1. In particular embodiments, the organic:aqueous ratio is from about 3:1 to about 10:1, or from about 7:1 to about 10:1.

Alternatively, the number of extractors in the secondary extraction stage can be increased. In one particular combination, the organic:aqueous ratio is from about 2:1 to about 3:1, and the secondary extraction stage contains 3 to 5 extractors.

Within the secondary extraction stage, the raffinate and the secondary organic phase composition can be considered to form a second mixture. It is noted that the pH of the second mixture should be maintained within the range of about 5 to about 12, or about 6.1 to about 12, or about 7 to about 10, or about 8 to about 9.5, or about 8 to about 10, or about 8 to about 12. The second mixture is then separated to obtain a lithium-depleted raffinate and a lithium-containing organic phase. The lithium-depleted raffinate exits the secondary extraction stage through line 180, and the lithium-containing organic phase exits the secondary extraction stage through line 182. This can also be considered an “Extraction B”.

The lithium-depleted raffinate is an aqueous solution that has been depleted of both metals (in the Extraction A) and lithium (in the Extraction B), and potentially magnesium as well. In some embodiments, from about 40% to 100% of the magnesium of the original feed has been removed from the lithium-depleted raffinate.

The remaining aqueous solution contains Na⁺, Ca²⁺, Ba²⁺, Sr²⁺, and/or K⁺ ions, usually in the form of chloride salts. This aqueous solution can be collected in tank 185. This aqueous solution may be useful for road salt applications. The pH of this aqueous solution will usually be from about 6 to about 10, or from about 7 to about 9.

If the secondary extraction stage is operated at a pH of about 11 to about 12, then calcium will also be extracted in the lithium-containing organic phase. The resulting aqueous solution collected in tank 185 would not have calcium, and would be viable as a raw material for PVC manufacturing.

Secondary Stripping

The metal-containing organic phase enters a secondary stripping circuit 190. The secondary stripping circuit is made up of at least one liquid-liquid extractor, and usually a set of such liquid-liquid extractors. As illustrated here, the secondary stripping circuit has two liquid-liquid extractors 192, 194. It is noted that generally any number of liquid-liquid extractors can be connected in series for the stripping process. In particular embodiments, it is contemplated that the secondary stripping circuit 190 can comprise from 1 to about 7 liquid-liquid extractors. In some embodiments, the secondary stripping circuit contains 1 or 2 extractors, and in other embodiments the secondary stripping circuit contains 3 to 5 extractors.

A second aqueous stripping solution 191 is fed into the secondary stripping circuit. The second aqueous stripping solution is acidic. In some particular embodiments, 3M HCl or 6M HCl is used, although of course other concentrations can be used. Concentrations of 0.1M to 12M can be effective. Other acids can also be used, such as acetic acid (HOAc), CO₂, H₂SO₄, HNO₃, carbonic acid, phosphoric acid, bisulfate, tartaric acid, oxalic acid, citric acid, or a combination thereof. A stabilizer is typically used with the HNO₃ to prevent significant oxidation of the organic phase components. Such stabilizers can include hydroxylamine, urea, sulfite, and the like. Generally, the pH of the second aqueous stripping solution is about 3 or less. When hydrochloric acid is used, the pH of the second aqueous stripping solution may rise as the acid is consumed to form lithium chloride, for example from about 0 pH to about 2 or 3. Alternatively, when CO₂ is used to acidify the water, the pH of the second aqueous stripping solution may start at about pH 4 and gradually reach a pH of about 6 as the lithium is stripped by the formation of lithium bicarbonate.

In FIG. 1, the second aqueous stripping solution and the lithium-containing organic phase (which might also contain Mg) flow counter-current to each other through the secondary stripping circuit. As illustrated here, the lithium-containing organic phase is fed into extractor BS1 192 through line 182 and then flows into extractor BS2 194. The second aqueous stripping solution is fed into extractor BS2 194 and then flows into extractor BS2 192. The secondary stripping circuit is usually operated at an organic:aqueous ratio (v/v) of about 1:10 to about 10:1, including from about 1:5 to about 5:1. For extraction of lithium, the organic:aqueous ratio should be at least 1:1, and can range from 1:1 to about 7:1 for effectiveness, including from about 1:1 to about 3:1. The residence time of the lithium-containing organic phase may range from about 30 seconds to about 5 minutes, including from about 1 minute to about 4 minutes, in the secondary stripping circuit.

The aqueous solution and the organic phase are then separated to obtain a lithium-containing aqueous solution/product and a lithium-stripped organic phase. The lithium-containing aqueous solution exits the secondary stripping circuit through line 193, and the lithium-stripped organic phase exits the secondary stripping circuit through line 195. The lithium-containing aqueous solution contains lithium, and is then collected in tank 200. The lithium concentration will be higher than in the primary aqueous solution. Desirably, the lithium concentration is at least 100 ppm, including from about 100 ppm to about 300 ppm, or about 1,000 ppm to about 3,000 ppm, and desirably may be in the range of about 20,000 to about 42,000 ppm (mg/L). In the form of lithium chloride (LiCl), the product concentration could be as high as 168 grams LiCl per liter if 12M stripping acid is used. If desired, the lithium chloride could be obtained in crystalline form.

Specifically, magnesium (Mg) may also be present in the lithium-containing aqueous solution, as it is generally separated along with the lithium. If magnesium is desired to be produced, only 1 extractor is needed in the secondary extraction stage, though 2 could be used, and only 1 or 2 extractors are needed in the secondary stripping circuit. The magnesium concentration may be in the range of about 20,000 to about 93,000 ppm (mg/L). In the form of magnesium chloride (MgCl₂), the product concentration could be as high as 372 grams MgCl₂ per liter. If desired, the magnesium chloride could be obtained in crystalline form.

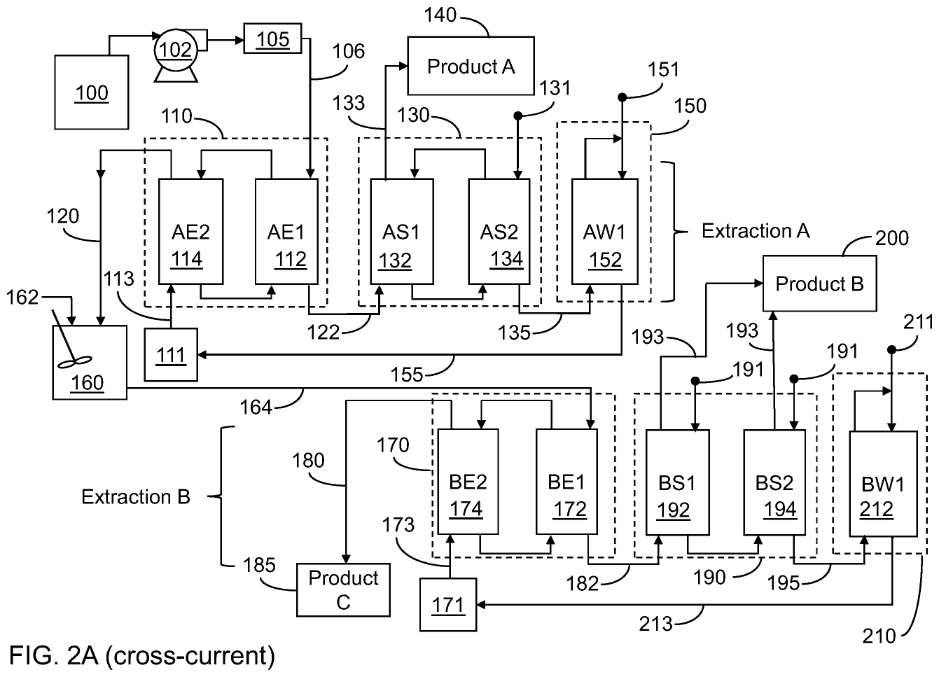

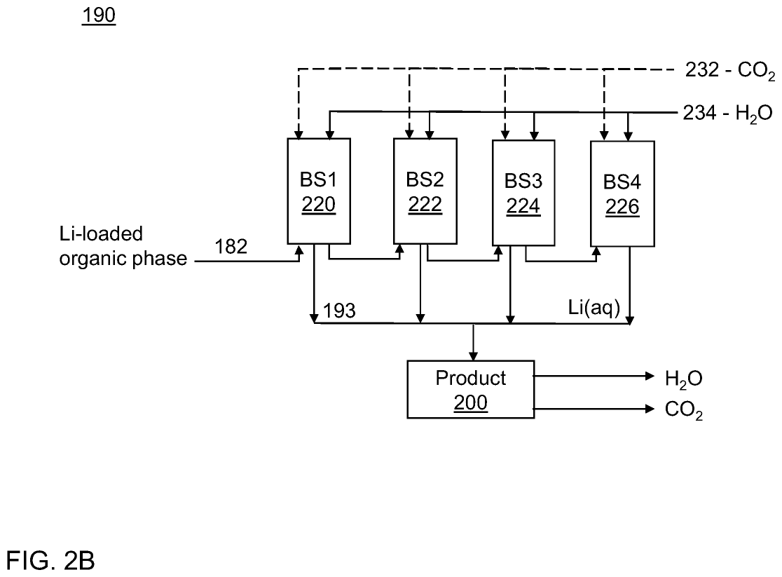

It has been discovered that in some embodiments, the lithium is more efficiently stripped from the lithium-containing organic phase (in line 182) using a cross-current flow (abbreviated herein as XC-LLX) rather than a counter-current flow, depending on the anion used in the second aqueous stripping solution. This is illustrated in FIG. 2A and FIG. 2B.

Referring first to FIG. 2A, each extractor BS1, BS2 192, 194 receives an independent feed of second aqueous stripping solution 191, and the lithium-containing aqueous solution exits each extractor through line 193 and is collected in tank 200. The lithium-containing organic phase is still fed into extractor BS1 192 and then flows into extractor BS2 194.

When the anion has a charge of −1, then higher lithium yields can be obtained when the secondary stripping is performed using XC-LLX. For example, if the anion is Cl⁻, OH⁻, or HCO₃⁻ or tartrate¹⁻ (or in other words acids like HCl or H₂CO₃ or monosodium tartrate are used), then the setup of FIG. 2A should be used. Aqueous strip solution is applied separately to each liquid-liquid extractor and collected separately, then combined later. It is noted that the majority of magnesium is concentrated in the first liquid-liquid extractor, and so this product stream can be separately maintained if it is desired to recover the magnesium separately from the lithium.

FIG. 2B is another embodiment of the secondary stripping stage 190. Here, carbonic acid is formed from the combination of CO₂ (via line 232) and water (via line 234) within each extractor BS1, BS2, BS3, and BS4 220, 222, 224, 226, which acts as the second aqueous stripping solution. The lithium-containing aqueous solution exits each extractor through line 193 and is collected in tank 200. The lithium-containing organic phase 182 is still fed into extractor BS1 220, then flows into extractor BS2 222, and sequentially into extractor BS3 224 and extractor BS4 226. The collected product in tank 200 can be concentrated or refined. In some embodiments, CO₂ and/or water can be recovered and recycled from tank 200.

When the anion has a charge of −2 or −3, then higher lithium yields can be obtained when the secondary stripping is performed using counter-current LLX as illustrated in FIG. 1. This is preferred when, for example, the acid used for the second aqueous stripping solution is sulfuric acid, Na₂CO₃, citric acid, or H₂CO₃, or disodium tartrate.

If calcium is present in the lithium-containing organic phase, calcium solids readily form, and these solids can be separated out from the lithium, for example by settling or filtering the solids out. Conveniently, these calcium solids will also form at a different pH from that of magnesium, so Ca and Mg products can be separated from lithium during the process.

Individual extractor stages can be operated at pH levels that permit the Li, Mg, and Ca to be separated from each other. Lithium can be selectively extracted at a pH of about 7 to about 8. Magnesium can be selectively extracted at a pH of about 9 to about 10. Calcium can be selectively extracted at a pH of about 11 to about 12. The aqueous raffinate of each stage could then be separately captured.

Secondary Wash

The lithium-stripped organic phase desirably now does not contain any lithium (or magnesium or calcium, depending on the targeted ion). The lithium-stripped organic phase is then sent to a secondary wash stage 210, where the organic phase is washed of any remaining stripping acid, or other reagent.

The secondary wash stage is made up of at least one liquid-liquid extractor, but can include two or more set of such liquid-liquid extractors. Only one liquid-liquid extractor 212 is illustrated. It is noted that generally any number of liquid-liquid extractors can be connected in series for the washing process. In particular embodiments, it is contemplated that the secondary wash stage 210 can comprise from 1 to about 5 liquid-liquid extractors.

A second aqueous wash solution 211 is fed into the secondary wash stage. The second aqueous wash solution can simply be water, such as deionized (DI) water is used, although of course minor concentrations of other ions can be present. The second aqueous wash solution can be slightly acidic, or may have a basic pH to neutralize residual acidity in the organic phase. Basic reagents such as dilute solutions of bicarbonate ion, carbonate ion, hydroxide ion, magnesium acetate or other pH-basic Mg compounds, sodium acetate, aqueous ammonia and alkyl amines, and the like may be present. Associated cations such as sodium, potassium, ammonium, and organic protonated amine can be present. Generally, the pH of the second aqueous wash solution is about 3 to about 8.5, including from about 3 to about 7, or from about 7 to about 8.5.

The second aqueous wash solution and the lithium-stripped organic phase flow counter-current to each other through the secondary wash stage. The secondary wash stage is usually operated at an organic:aqueous ratio (v/v) of about 1:10 to about 10:1, including from about 1:5 to about 5:1. The residence time of the lithium-stripped organic phase may range from about 30 seconds to about 5 minutes, including from about 1 minute to about 4 minutes, in the secondary wash stage.

The second aqueous wash solution and the organic phase are then separated. This washed secondary organic phase can be sent through wash recycle line 213 back to the secondary extractant tank 171 to be used in the secondary extraction stage or sent back to the primary extractant surge tank 111. The second aqueous wash solution can be recycled through the secondary wash stage, or can be reused, purged, processed for any concentrated values collected there, used to prepare the aqueous stripping solution, etc.

### SUMMARY

The methods of the present disclosure produce three different products. The Product A of tank 140 is an aqueous solution of metal salts such as Al, Fe, Ni, Mn, Zn, and potentially copper (Cu). This may be useful for recovering these metals. The Product B of tank 200 is an aqueous solution containing concentrated high-value lithium, and/or magnesium, and/or calcium. It is noted that the lithium, magnesium, and calcium can also be further selectively separated from each other, so additional product tanks could be included here. The Product C of tank 185 is an aqueous solution containing Na⁺ and/or K⁺, and potentially Ca²⁺. This may be useful in road salt applications, or with the Ca removed as discussed above, useful for making PVC plastic, e.g. for water piping or siding for buildings.

As previously described, the primary aqueous solution entering the primary extraction stage 110 (“Extraction A”) has a pH of from about 3 to about 8, and the metal-reduced raffinate entering the secondary extraction stage 170 (“Extraction B”) through line 164 has a pH of about 5 to about 12. In more specific embodiments, the primary aqueous solution entering the primary extraction stage has a pH of from about 3 to about 6, and the metal-reduced raffinate entering the secondary extraction stage 170 has a pH of about 6.1 to about 10.5. In a still more specific embodiment, the primary aqueous solution entering the primary extraction stage has a pH of from about 3 to about 6, and the metal-reduced raffinate entering the secondary extraction stage, and where it is desired to not collect Ca with the Li and Mg, 170 has a pH of about 6.1 to about 9.5.

The following examples are provided to illustrate various aspects of the present disclosure. The examples are merely illustrative and are not intended to limit the disclosure to the materials, conditions, or process parameters set forth therein.

### EXAMPLES

### Example 1

An organic extractant composition was made that contained 25 vol % N-isopropyl-n-nonanohydroxamic acid, 5.0 vol % decyl alcohol, and 70 vol % odorless kerosene. These ingredients were blended in a 5-liter reactor at 306 rpm with internal reactor temperature (T) of 19° C. for 15 minutes.

Batch tests using pH control for lithium extraction were performed. 250 mL of flow back water (FBW) was provided, which had a measured density of 1.152 g/cc. 1,750 mL of the organic extractant composition was used. The FBW formed a lower layer (LL), and the organic phase formed the upper layer (UL). The UL/LL ratio (v/v) was 7:1, and the reactor volume was 2 L.

### Run #3

In a first experiment, the pH of the LL was maintained at 7.0, and the contents were mixed for 16 minutes, then separated. The lithium-depleted aqueous phase was designated “Raffinate B”. The lithium-containing organic phase was then stripped one time with an 3M HCl aqueous solution of pH 2.5 for 25 minutes. The organic:aqueous strip ratio was 15.5.

In a second experiment, the pH of the LL was maintained at 8.0, and the contents were mixed for 25 minutes, then separated. The lithium-containing organic phase was then stripped one time with an 3M HCl aqueous solution of pH 2.5 for 25 minutes. The organic:aqueous strip ratio was 15.5. The organic phase was then scrubbed with a 2% Na₂CO₃ solution for 25 minutes. Finally, the organic phase was rinsed with deionized (DI) water for 25 minutes.

The amounts of lithium (Li) and magnesium (Mg) in various samples were measured using ICP-OES. The results are provided below:

| pH | Process Sample | Li (mg/L) | Mg (mg/L) |
|---|---|---|---|
| — | Feed | 156 | 729 |
| 7.0 | Raffinate B | 24.1 | <2.50 |
| 7.0 | 3M HCl strip solution | 222 | 23.6 |
| 8.0 | 2% Na₂CO₃ scrub solution | 19.6 | 6.25 |
| 8.0 | DI water rinse | 8.81 | <2.50 |

Very good Li extraction (84.6%) and excellent Mg extraction (>99.7%) were obtained with just one stage. The Li concentration in the stripping solution was high-yielding with respect to the Li.

### Run #4

Next, the pH of the reactor was adjusted in different ways. The UL/LL ratio (v/v) was 7:1, and the contents were mixed for 25 minutes.

First, the pH of the LL was maintained at 4.5, and the contents were mixed, then separated.

Second, the pH of the LL was not controlled. Instead, 50% NaOH was added in increments.

Third, the pH of the LL was not controlled. 2% Na₂CO₃ was addedin increments

Fourth, the UL/LL ratio (v/v) was increased to 7:1.

Fifth, the pH was raised with 4×1.000 mL of 50% NaOH.

The amounts of lithium (Li) and magnesium (Mg) in the aqueous phase were measured using ICP-OES. The results are provided below:

| pH | Process Sample | Li (mg/L) | Mg (mg/L) |
|---|---|---|---|
| — | Feed | 156 | 729 |
| 4.5 | Aqueous phase | 147 | 696 |
| | 50% NaOH aqueous | 126 | 124 |
| | 2% Na₂CO₃ aqueous | 97.5 | 108 |
| | Higher UL/LL ratio | 105 | 13.0 |
| | 4 × 1.000 mL of 50% NaOH aqueous | 55.8 | 18.9 |

The pH 4.5 results show that Li will not be extracted at the conditions present in the first extraction stage, where the pH is roughly between 3 and 5.

Comparing the 50% NaOH versus 2% Na₂CO₃ results, the use of Na₂CO₃ doubled the extraction efficiency of Li (from 14.2% to 28.6%). The extraction efficiency of Mg, already high, did not increase as much (from 82.2% to 84.3%).

When the UL/LL ratio was increased, the extraction efficiency also increased. % E(Li)=28.6%, and % E(Mg)=98.1%.

Finally, raising the pH (i.e. more basic) resulted in substantial improvement in extraction efficiency. % E(Li)=62.0%, and % E(Mg)=97.3%.

### Run #5

Next, the pH of the reactor was adjusted in more ways. The UL/LL ratio (v/v) was 7:1.

First, the pH of the LL was raised to pH 8.5, and the contents were mixed for 25 minutes, then separated.

Second, the pH of the LL was raised to pH 8.5, and the contents were mixed for only 5 minutes, then separated. The lithium-containing organic phase was then stripped one time with a very small volume of an 3M HCl aqueous solution of pH 2.5. The organic:aqueous strip ratio was 7100:100.

The amounts of lithium (Li) and magnesium (Mg) in various samples were measured using ICP-OES. The results are provided below:

| pH | Process Sample | Li (mg/L) | Mg (mg/L) |
|---|---|---|---|
| — | Feed | 156 | 729 |
| 8.5 | Aqueous phase | 128 | 2.69 |
| 8.5 | 5 min mix aqueous phase | 124 | 7.93 |
| | 7100/100 strip | 37.2 | 3320 |

### Runs #6, #7, #8

Multiple trials were conducted to determine reproducibility. The UL/LL ratio of (v/v) of the reactor was 7:1. 1,386 microliters (μL) of 50% NaOH were added over the mixing period of 25 minutes, then the contents were separated. The organic phase (1,750 mL) was stripped with 98.00 mL of 3M HCl. This procedure was repeated for three different batches.

The amounts of lithium (Li) and magnesium (Mg) in the aqueous phase and the strip solutions were measured using ICP-OES. The results are provided below:

| pH | Process Sample | Li (mg/L) | Mg (mg/L) |
|---|---|---|---|
| — | Feed | 156 | 729 |
| 8.90 | Aqueous Batch 1 | 126 | 401 |
| 8.89 | Aqueous Batch 2 | 143 | 384 |
| 8.89 | Aqueous Batch 3 | 141 | 550 |
| | Strip solution Batch 1 | 21.8 | 230 |
| | Strip solution Batch 2 | 14.6 | 181 |
| | Strip solution Batch 3 | 18.1 | 153 |

Precision pH adjustment resulted in specific and predictable extractions of Li and Mg products.

### Runs #9, #10, #11

Multiple trials were conducted to determine the effect of the organic:aqueous ratio in the stripping phase. The UL/LL ratio of (v/v) of the reactor was 7:1. 50% NaOH was added over the mixing period of 25 minutes, then the contents were separated. The organic phase (1,750 mL) was stripped with 3M HCl. The organic:aqueous ratio in the stripping phase was 8.75, 11.7, or 17.5.

The amounts of lithium (Li) and magnesium (Mg) in the aqueous phase and the strip solutions were measured using ICP-OES. The results are provided below:

| pH | Process Sample | Li (mg/L) | Mg (mg/L) |
|---|---|---|---|
| — | Feed | 156 | 729 |
| 8.89 | Aqueous Batch 1 | 142 | 201 |
| 9.22 | Aqueous Batch 2 | 136 | 179 |
| 9.1 | Aqueous Batch 3 | 129 | 231 |
| | Strip solution E/A = 8.75 | 6.14 | 282 |
| | Strip solution E/A = 11.7 | 13.6 | 670 |
| | Strip solution E/A = 17.5 | 23.4 | 1,180 |

The results indicated that a higher organic:aqueous ratio in the stripping phase enabled high concentrations of Li and Mg products.

### Example 2

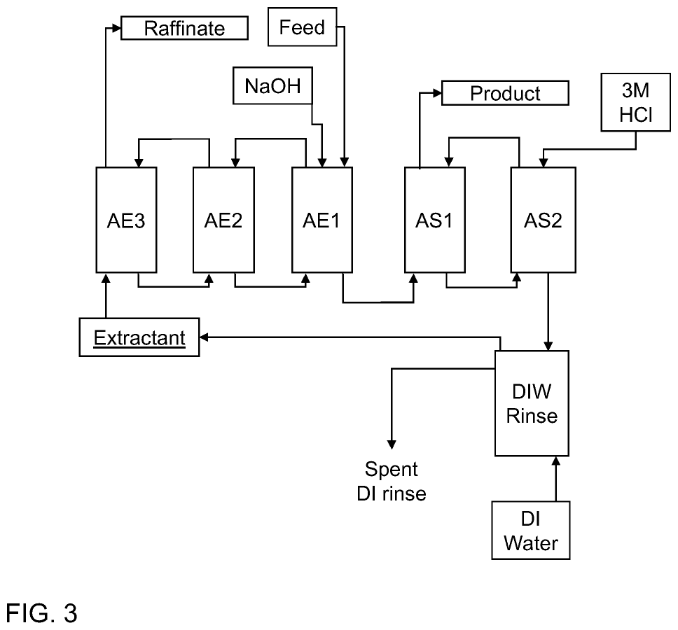

A separate CCLLX unit “A” was operated. This unit is illustrated in FIG. 3, and corresponds to the Extraction A portion of FIG. 1.

The FEED was 56.9 kg of flow back water (FBW) stored under argon, which was kept anaerobic and was naturally free of radioactivity. The FEED contained 156 mg Li/liter.

The extractant composition contained 25 vol % N-isopropyl-n-nonanohydroxamic acid, 5.0 vol % decyl alcohol, and 70 vol % odorless kerosene. The extractant was on a large diaphragm pump, also fitted with recycle for control of flow rate.

Hydrochloric acid (for stripping Li) was prepared by stirring 0.61 liters of 31.5% Muriatic Acid (12 M) into 1.83 liters of DI water. The total 3M HCl produced was 6.25 liters. This acid was transferred to a 2.5 gal carboy used to feed the strippers (S1-S2 of FIG. 3) using a diaphragm compressed air pump. The 3M HCl was on a large diaphragm pump with recycle back to the feed tank to enable close control of flow to the LLX unit.

DI wash was added manually as needed to the DIW Rinse stage.

### “Extraction A” #1

Mixer shear affects the interfacial surface area within the emulsion. A droplet size range of about 0.1 mm to about 1.0 mm diameter was targeted. Each CCLLX stage included an overhead stirrer with a 1-inch-diameter mixing disc that is designed to produce such spherules and 100% mixing of the lower layer (LL) with the upper layer (UL). Mixer shear is related to the spin rate of this mixing disc. RPM data was collected and controlled to produce these conditions. The mixing speed for the apparatus is normally about 900 rpm to about 1500 rpm, depending on the E/A ratio, fluid flow rates, and whether the mixer included a pH probe and/or a NaOH solution feeding tube.

In this run, the CCLLX-A unit of FIG. 3 was operated as the primary extraction stage (reference numerals 110, 130, 150 in FIG. 1). 10 kilograms of raffinate A (line 120 in FIG. 1) was produced for this test. The raffinate A is cleaned of Al and Fe, but still contains Li and Mg. The raffinate A is renamed FEED-B when fed to the secondary stage for Li and Mg extraction, as discussed further below.

Referring now to FIG. 3, the CCLLX-A unit was fitted with 3 Extractors, 2 Strippers, and one DI Water Rinse. The RPMs for each extractor were: E1=1217, E2=1365, E3=1345, S1=1406, S2=1312, and AQ wash (both Na₂CO₃ scrub and DIW rinse)=1415.

The FEED was pumped into AE1. Aqueous HCl was pumped into AS2. The UL (extractant) was fed to AE3. Air pressure used was 50 psi. All flows were running steady after 33 minutes. After 30 more minutes, the aqueous stream exiting AE3 was collected. The pH of the AS1 mixer was 1.5. The aqueous stream exiting AS1 was collected.

The setpoint for S1 was 72.5 mg Li/L.

Readings: HCl pump psi: 2-20 pulsing; PIRANHA pump 0-2 psi pulsating; FEED A pump psi=0-2 psi pulsating: Air compressor psi line side=75 psi.

Initially, in extractor AE1, the UL=−100% and LL=−0%. This indicated the LL was beneath the settler in the piping. The interface weir was quickly adjusted upwards after this reading so that UL=−50% and LL=−50%. InA E2, UL=55% and LL=45%. In AE3, a 1:1 ratio of UL=50% and LL=50% was achieved.

In stripper AS1, UL=10% and LL=90%. In AS2: UL=60% and LL=10%, with the balance being an emulsion band at the interface.

In the Na₂CO₃ scrubber and the DIW rinse units, UL=20% and LL=80%.

These results accomplished the objective of achieving an operable and stable CCLLX system. During an operation period of 2 hours 20 minutes, 6.2 kg of raffinate A was produced, for a production rate of 44.3 g/min of raffinate product.

In the raffinate collected from E3, the lithium concentration was 146 mg Li/L. This result indicated very little lithium was lost during the primary extraction step (targeting Al/Fe removal). This also suggests the same extractant could be used in both extraction stages (A and B), where the Extraction B stage targets Li and Mg extraction This means the operational complications of having to handle and use two different extractant compositions can be avoided. Referring back to FIG. 1, this means that potentially, the two extractant tanks 111, 171 could be combined into a single extractant tank. Similarly, the two wash stages 150, 210 could be combined into a single wash stage.

Loss of Li to DI Water Rinse Stage

The spent DI rinse water, only added manually and operated as internal recirculation, accumulated only 134 mg Li/L. This result was interpreted to mean that the wash stream captures very small quantities of accumulated Li, and only very low Li levels remain after the two strip stages AS1, AS2. This suggests using a third stripping stage could capture this residual Li.

### “Extraction A” #2

The objective of this run, using the unit depicted in FIG. 3, was to achieve steady-state operation and to remove Al and Fe metals without extracting meaningful amounts of Li or Mg. The FEED A contained 156 mg Li/liter.

The RPMs for the stirrer in each extractor were AE1=1358, AE2=1224, AE3=1031, AS1=1179, AS2=1150, and WASH=1307.

The AQ Product of AS1 was sampled for Li, and analyzed by ICP-OES. The Li concentration was 108 mg/L.

Spent DI wash water was also changed out when it reached pH 1. This stream, highly recirculated for efficiency, contained only 63.3 mg Li/L.

The aqueous raffinate exiting AE1, AE2, and AE3 were sampled. The Li concentration of AE1=146 mg/L and AE2=144 mg/L. Finally, the Li concentration of AE3=146 mg/L. These measurements, when compared to the FEED, show little to no loss of Li in the raffinate stream. This is exactly as desired for the technology. The “A Extraction” (also called CC-LLX-A) is targeted to extract Al and Fe metals, and to not extract Li and Mg ions at all, and it did not. It was unexpected to obtain such high selectivity at the mild pH values of the FEED (pH 6.18).

The amount of raffinate being released smoothly by stage AE3 was as intended at the steady flow conditions. AE3 product yield was 13.2 kg. The Li concentration was 146 mg Li/L. The pH of the raffinate A produced was measured as 6.18.

The product from AS1 had a Li concentration of 153 mg/L and a Mg concentration of 698 mg/L.

This product was re-extracted (see below) to recover Li and Mg still contained therein.

### Extraction B #1

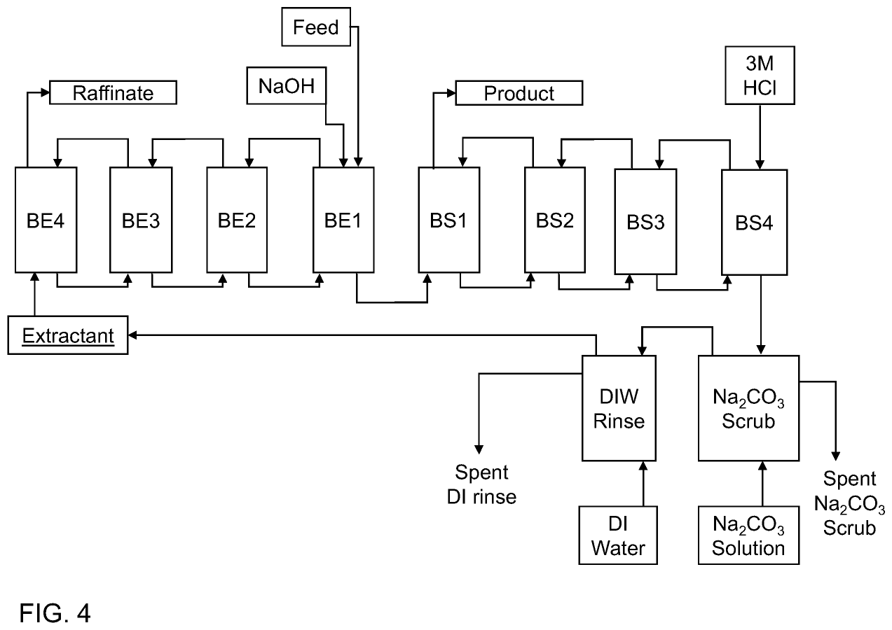

The 13.2 kg of raffinate A from Extraction A #2 (15.12 L; density=1.1524 g/mL) was combined with 37.93 grams of slaked lime to adjust its pH from 6.18 to pH 9 (using Hydrion® pH paper), and used as FEED B for this test run. The unit used was as depicted in FIG. 4, and corresponds to the Extraction B portion of FIG. 1.

The goal of this test run was to continuously extract Li and Mg from FEED B. The amount of FEED B available was 8.8 L.

The FEED B was introduced slowly and under control, using compressed air driven (50-70 psi) diaphragm pumps fitted with adjustable by-pass recirculation capability. The pumping rate was kept slow to provide a target residence time in the mixer of about 2 minutes.

After 1.5 hours, the Raffinate B output was smoothly exiting the system as normal. After 1.75 hours, 2.2 L of Raffinate B product had been collected.

After 2 hours, the flow of the upper layer organic phase (UL) was noted to be starved. Pressure from the pump was increased to restart UL flow. After 2.5 hours, the pH of extractor BE3 had dropped to 2.8. This pH is too low for the extraction of either Li or Mg.

After 3.0 hours, 2.9 L of Raffinate B product had been collected. It had a very faint dilute lemonade color. After 3.5 hours, 3.7 L of Raffinate B product had been collected. However, the pH of the LL in extractor BE3 mixer had fallen to 5.0. The E/A ratio was measured as 1:7. The feed flows were adjusted to provide an E/A ratio of 7:1.

After approximately 3.8 hours, samples were collected from the Raffinate B tank, which was at a filled level of 6.23 L (of the 8.8 L available from the start of the run).

After approximately 4 hours, the FEED B tank had a level of 4.5 L (of the 8.8 L initial feed). (The system was started already charged with 3-4 L FEED/RAFF B.) The product from stripper BS1 was collected in two separate carboys having 2.5 gallon capacity.

After approximately 5.8 hours, the pH of the Raffinate B was 3.0. The test run was stopped, since Li and Mg cannot be extracted at this pH. Samples were taken from extractors BE3, BE2, BE1, BS2, and the DI wash.

Results

The sample from the carboy, which collected the output from the stripper, yielded a lithium concentration of 130 mg/L.

The Raffinate B product had an Li concentration of 143 mg/L. This is an 8.37% drop from the original 156 mg/L present in the original Feed of Extraction A.

It was thus determined that a pH control device was needed to keep the pH in the 8.0 to 9.5 range to successfully extract Li, and preferably in the 8.5-9.0 range. It is believed that this pH control during the extraction would neutralize the free acid “H+” ions that are released each time the hydroxamic acid extracts a lithium ion.

A pH titration curve was also prepared by potentiometric pH titration with standard sodium hydroxide (NaOH) of the stirred UL/LL mixture. This pH titration curve also indicated that still higher pH set points are needed to extract Mg²⁺ too with basic (alkaline) pH control. For Mg²⁺ recovery, the preferred pH was about 10, more preferably a pH of 10.2. For Ca²⁺ recovery the desired pH is from about 11.9 to about 12.6, such as about 12.2, even more preferably a pH of about 11.98, and most preferably a pH of about 12.56. In this manner the Ca extraction can be separated from the Li+Mg extraction, and then produce a Ca-free raffinate that could be used in PVC production.

Finally, it was determined that the acid (normally 3-6 M HCl) stripped organic phase benefits from being cleaned with an alkaline sodium carbonate solution. Specifically, a 2-7% Na₂CO₃, or milk-of-lime (water slurry of Ca(OH)₂) scrub solution removes excess acid from the organic extractant phase between uses.

### Example 3

Batch experiments were conducted (using a 5.00 L graduated glass reactor and mechanical overhead stirrer with bottom drain) to determine how to maximize extraction of magnesium (Mg), using the device of FIG. 4.

The FEED B liquid contained 143 mg Li/L and 699 mg Mg/L. The pH of the FEED B liquid was measured as 6.18.

The extractant composition contained 25 vol % N-isopropyl-n-nonanohydroxamic acid, 5.0 vol % decyl alcohol, and 70 vol % odorless kerosene. The extractant composition was scrubbed after each UL use with sodium carbonate and DI water.

The organic extractant and the aqueous FEED B liquid were mixed together at different E/A ratios (equivalent to UL/LL). 50% NaOH was added in various amounts to adjust the pH upwards, and then mixed for 5 minutes. Sodium acetate (2% sodium acetate trihydrate) was used to scrub each LLX test. This base does not promote carbonate solids formation, and can also be washed out of the organic phase. The pH after scrubbing gave 6.5-7.0. The acid for the stripping step was 3.00M HCl (made from 37% HCl).

Both phases were separated using a separatory funnel and LL samples were taken. The Li and Mg concentration of the LL samples were then determined. Results are present in the following table below:

| | Stir | | E/A | | | | Amt 50% | | Sample | | |
|---|---|---|---|---|---|---|---|---|---|---|---|
| | speed | | ratio | Amt E | Amt A | tPS | NaOH added | pH | vol | [Li⁺] | [Mg²⁺] |
| Run | (RPM) | pH | (v/v) | (mL) | (mL) | (sec) | (μL) | after | (mL) | (mg/L) | (mg/L) |
| 1 | 900 | 7.06 | 1/4 | 15 | 60 | 300 | 2157.3 | 12.56 | 40 | 117 | 28.9 |
| 2 | 1200 | 7.32 | 1/4 | 15 | 60 | 60 | 1000 | 11.98 | | 126 | 73 |
| 3 | | | 1/4 | | | | | 11.98 | | 131 | 18.8 |
| 4 | 1400 | 7.12 | 1/1 | 60 | 60 | 60 | 2157.3 | 10.50 | 60 | 118 | 5.81 |
| 5 | 1400 | 7.45 | 2/1 | 120 | 60 | 60 | 2000 | 10.94 | 60 | 112 | 4.64 |
| 6 | 1400 | 1.23 | 3/1 | 180 | 60 | 60 | 2000 | 10.71 | 60 | 115 | 2.63 |
| 7 | 1100 | 7.43 | 5/1 | 200 | 40 | 60 | 1438.2 | 10.50 | 40 | 107 | <2.50 |
| 8 | 1300 | 6.80 | 5/1 | 200 | 40 | 120 | 1438.2 | 10.76 | 40 | | |
| 9 | 1100 | 7.31 | 7/1 | 210 | 30 | 60 | 1078.6 | 11.75 | 3 | 69.9 | <2.50 |
| 10 | 1300 | 7.33 | 7/1 | 210 | 30 | 80 | 1078.6 | 10.77 | 30 | | |
| 11 | 1400 | 7.98 | 10/1 | 200 | 20 | 60 | 719.1 | 10.92 | 20 | 114 | <2.50 |
| 12 | 1100 | 7.68 | 10/1 | 200 | 20 | 60 | 799.1 | 11.06 | 20 | | |
| 13 | 1400 | 7.27 | 10/1 | 200 | 20 | 60 | 739.1 | 10.75 | 20 | | |

This data indicates that Mg²⁺ ions are readily extracted in high yield. With the E/A ratio in the range of about 5/1 through at least 10/1, 100% of the Mg is extracted in just one LLX contact stage (detection limits <2.5 mg/L).

### Example 4

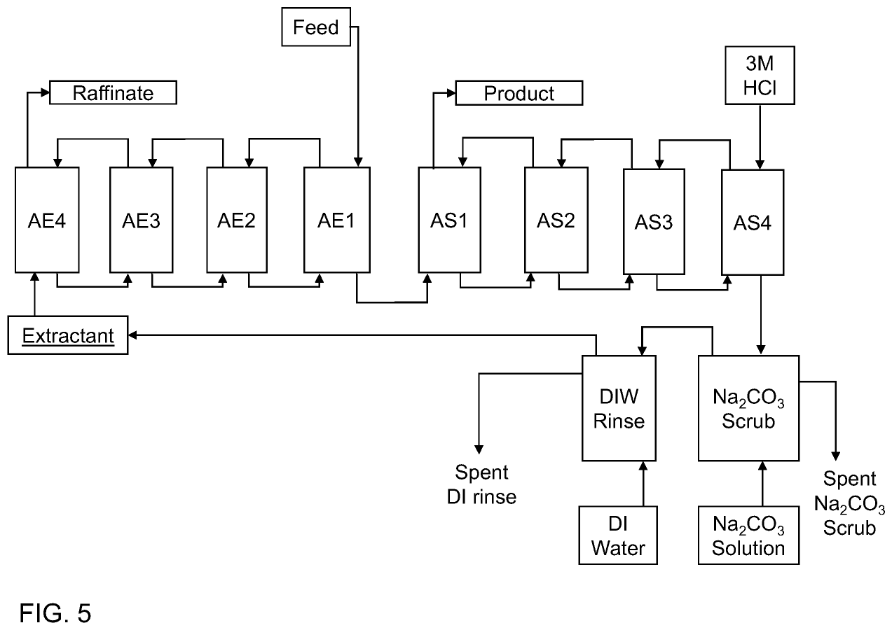

The pH was maintained between pH 5 to pH 7, and the results were measured in several different locations in the primary extraction stage as illustrated in FIG. 5. This simulates the “Extraction A” stage, which is intended to remove Al and Fe, so that Li can be better captured in the “Extraction B” stage. It is noted that FIG. 5 is similar to FIG. 4.

It is noted the starting Li concentration in the Feed was 120 mg/L, and the starting Mg concentration was 677 mg/L.

| Settler | [Li] (mg/L) | [Mg] (mg/L) | pH range |
|---|---|---|---|
| Feed | 120 | 677 | |
| AE4 | 134 | 617 | pH 5 to pH 7 |
| AE3 | 124 | 582 | pH 5 to pH 7 |
| AE2 | 126 | 596 | pH 5 to pH 7 |
| AE1 | 126 | 600 | pH 5 to pH 7 |
| AS1 | 4.38 | 16.5 | — |
| AS2 | 3.81 | 13.1 | — |
| AS3 | 2.8 | 5.86 | — |
| AS4 | <2.50 | <2.50 | — |
| Rinse | 19.4 | 108 | |
| Raffinate | 139 | 647 | pH 5 to pH 7 |
| AS1 Product | 86.7 | 421 | — |
| Scrub Raffinate | 6.56 | 27.5 | Low |
| Wash Water | 61.4 | 315 | Low |

The results indicated that almost no Li was extracted in a pH range of 5-7, as seen by the difference between the Feed and the Raffinate (which is used as the input to the “Extraction B” stage).

### Example 5

Experiments were conducted using a device similar to FIG. 4, using four extractors and four strippers. However, the strippers were arranged in a cross-current flow, like that illustrated in FIG. 2B.

### Run #1

First, the concentration of Li, Mg, Ca, and Na was measured in secondary extraction stage BE1 at different pH levels. 50% NaOH was used to control the pH.

The extractant composition contained 25 vol % N-isopropyl-n-nonanohydroxamic acid, 5.0 vol % decyl alcohol, and 70 vol % odorless kerosene. The extractant composition was scrubbed after each UL use with sodium carbonate and DI water.

The organic extractant and the aqueous FEED B liquid were mixed together at an E/A ratio of 7:1. The pH was controlled using carbonic acid. LL samples were taken from extractor BE1. The Li, Mg, Ca, and Na concentrations of the LL samples (aqueous raffinate) were then determined. Results are presented in the following table below, organized by pH:

| Sample | pH | [Li] (mg/L) | [Mg] (mg/L) | [Ca] (mg/L) | [Na] (mg/L) |
|---|---|---|---|---|---|
| FEED-B | | 114 | 699 | 9,670 | 25,300 |
| 126 BE1 | 8.62 | 108 | 583 | 8,950 | 24,900 |
| 131 BE1 | 8.35 | 102 | 581 | 8,380 | 24,800 |
| 128 BE1 | 7.86 | 110 | 602 | 9,120 | 24,300 |
| 130 BE1 | 7.47 | 78.9 | 466 | 6,650 | 19,500 |
| Average | | 99.7 | 558 | 8,275 | 23,375 |
| % Change | | 12.5 | 20.2 | 14.4 | 7.6 |

This data showed that Li, Mg, and Ca can be selectively extracted and leave Na behind in the aqueous raffinate. Desirably, Na is not transferred to the organic extractant phase.

### Run #2

Next, the concentration of Li, Mg, Ca, and Na in the aqueous raffinate was measured in all four secondary extraction stages BE1, BE2, BE3, and BE4. Results are presented in the following table below:

| Sample | pH | [Li] (mg/L) | [Mg] (mg/L) | [Ca] (mg/L) | [Na] (mg/L) |
|---|---|---|---|---|---|
| FEED-B | | 114 | 699 | 9,810 | 27,100 |
| BE1 | 8.80 | 104 | 659 | 12,600 | 24,300 |
| BE2 | 9.00 | 42.7 | 74.5 | 2,910 | 13,700 |
| BE3 | 8.10 | 46.6 | 200 | 2,100 | 17,000 |
| BE4 | 7.90 | 25.7 | 119 | 550 | 11,200 |

This data indicated that these pH levels were good for recovering lithium, magnesium, and calcium.

Next, the concentration of Li, Mg, Ca, and Na in the aqueous raffinate was measured in all four secondary cross-current stripping stages BS1, BS2, BS3, and BS4 for various pH levels. Results are presented in the following table below.

| | | | [Mg] | [Ca] | |
|---|---|---|---|---|---|
| Sample | pH | [Li] (mg/L) | (mg/L) | (mg/L) | [Na] (mg/L) |
| BS1 | 6.17 | 47.4 | 388 | 3,440 | 13,100 |
| BS2 | 6.18 | 25.8 | 247 | 1,840 | 7,120 |
| BS3 | 6.27 | 12.6 | 154 | 1,690 | 3,580 |
| BS4 | 6.27 | 4.89 | 63.7 | 861 | 1,390 |
| Total Li collected | | 90.69 | | | |

This data indicated that these carbonic acid pH levels were good for stripping lithium from the organic phase (containing extractant) back into the aqueous stripping solution.

The total amount of Li, Mg, Ca, and Na collected from each secondary cross-current stripping stage BS1, BS2, BS3, and BS4 was measured. Results are presented in the following table below.

| | | | [Mg] | [Ca] | |
|---|---|---|---|---|---|
| Sample | pH | [Li] (mg/L) | (mg/L) | (mg/L) | [Na] (mg/L) |
| BS1 | 6.4 | 46.6 | 660 | 2,070 | 13,700 |
| BS2 | 6.4 | 34.8 | 525 | 1,540 | 10,500 |
| BS3 | 6.4 | 16.8 | 198 | 1,130 | 4,900 |
| BS4 | 6.4 | 13.2 | 111 | 1,240 | 3,790 |
| Total Li collected | | 111.4 | | | |

The stripping stages thereby captured 97.7% the concentration of the original FEED B. This showed that cross-current flow enabled high yield with respect to stripping Li from the loaded extractant phase. This also suggests that 5 or 6 stripping stages would collect almost 100% of the Li.

Finally, different UL/LL ratios were used in each secondary cross-current stripping stage BS1, BS2, BS3, and BS4 (all the same dimensions) and the amount of Li, Mg, Ca, and Na was measured. Results are presented in the following table below.

| | | | [Li] | [Mg] | [Ca] | [Na] |
|---|---|---|---|---|---|---|
| Sample | pH | UL/LL | (mg/L) | (mg/L) | (mg/L) | (mg/L) |
| BS1 | 6.61 | 1:2 | 92.6 | 624 | | 29,000 |
| BS2 | 6.44 | 1:10 | 87.2 | 614 | | 27,400 |
| BS3 | 6.25 | 1:1 | 62.9 | 460 | | 19,800 |
| BS4 | 6.06 | 1:3 | 61.4 | 448 | | 17,800 |
| Total Li | | | 304.1 | | | |
| collected | | | | | | |

This data indicated that these pH levels produced by recycling carbonic acid containing extractant back into the aqueous stripping solution were effective for stripping lithium from the organic phase using cross-current fluid flow.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A method for separating lithium from a primary aqueous solution, comprising:
contacting the primary aqueous solution with an initial organic liquid phase composition in a primary extraction stage to form a first mixture, wherein the initial organic phase composition comprises a hydroxamic acid;
separating the first mixture to obtain a metal-reduced raffinate and a metal-containing organic phase;
contacting the metal-reduced raffinate with a secondary organic phase composition in a secondary extraction stage to form a second mixture, wherein the secondary organic phase composition comprises a hydroxamic acid;
maintaining the pH of the second mixture at a pH of about 5 to about 12;
separating the second mixture to obtain a lithium-depleted raffinate and a lithium-containing organic phase; and
stripping the lithium-containing organic phase with an acidic aqueous solution to obtain the lithium in a lithium-containing aqueous solution.

2. The method of claim 1, wherein the primary extraction stage is operated at an organic:aqueous ratio (v/v) of about 1:10 to about 10:1; or
wherein the metal-containing organic phase comprises Al or Fe ions originally present in the primary aqueous solution; or
wherein the primary aqueous solution has a pH of about 3 to about 8, and wherein the metal-reduced raffinate has a pH of about 3 to about 5.

3. The method of claim 1, wherein the primary extraction stage is in the form of a first set of liquid-liquid extractors arranged for counter-current flow.

4. The method of claim 3, wherein the first set comprises 1 to about 7 liquid-liquid extractors.

5. The method of claim 1, further comprising stripping the metal-containing organic phase to obtain a first aqueous product containing metal salts.

6. The method of claim 5, wherein the metal-containing organic phase is stripped with HCl, acetic acid, CO₂, H₂SO₄, HNO₃, carbonic acid, phosphoric acid, bisulfate, tartaric acid, oxalic acid, citric acid, or a combination thereof.

7. The method of claim 5, wherein the metal-containing organic phase is stripped in a primary stripping circuit comprising a set of liquid-liquid extractors arranged for counter-current flow or cross-current flow.

8. The method of claim 7, wherein the primary stripping circuit comprises 1 to about 7 liquid-liquid extractors.

9. The method of claim 1, wherein the pH of the metal-reduced raffinate is adjusting using a base.

10. The method of claim 9, wherein the base is Ca(OH)₂, Mg(OH)₂, Zn(OH)₂, NaOH, CaO, MgO, ZnO, KOH, an ammonium compound, an amine, ammonium hydroxide, bicarbonate ion, carbonate ion, hydroxide ion, magnesium acetate, sodium acetate, aqueous ammonia, or a combination thereof.

11. The method of claim 1, wherein the secondary extraction stage is in the form of a second set of liquid-liquid extractors arranged for counter-current flow.

12. (canceled)

13. The method of claim 1, wherein the secondary extraction stage is operated at an organic:aqueous ratio (v/v) of about 1:10 to about 10:1; or
wherein the lithium-depleted raffinate comprises Na⁺, Ca²⁺, Ba²⁺, Sr²⁺, or K⁺ ions; or
wherein the lithium-depleted raffinate has a pH of about 7 to about 10; or
wherein the acidic aqueous solution comprises HCl, acetic acid, CO₂, H₂SO₄, HNO₃, carbonic acid, phosphoric acid, bisulfate, tartaric acid, oxalic acid, citric acid, or a combination thereof.

14. The method of claim 1, wherein the lithium-containing organic phase is stripped in a secondary stripping circuit comprising a set of liquid-liquid extraction columns arranged for counter-current flow.

15. (canceled)

16. The method of claim 1, wherein the lithium-containing aqueous solution further contains Mg²⁺ ions; or
wherein the hydroxamic acid is N-isopropyl-n-decyl-hydroxyamic acid, or N-isopropyl-n-nonanohydroxamic acid, or N-ethyl-n-nonanohydroxamic acid.

17. The method of claim 1, wherein the initial organic phase composition comprises the hydroxamic acid, an organic solvent, and optionally an alcohol modifier.

18. The method of claim 17, wherein the initial organic phase composition comprises about 1 to about 75 vol % of the hydroxamic acid, about 5 to about 97 vol % of the organic solvent, and about 1 to about 30 vol % of the alcohol modifier.

19-22. (canceled)

23. A first aqueous product containing Al and Fe salts, produced by the method of claim 1.

24. (canceled)

25. A second aqueous product containing lithium, produced by the method of claim 1.

26. (canceled)

27. A third aqueous product containing sodium, calcium, and/or potassium, produced by the method of claim 1, and containing less than 300 ppm of lithium, or less than 50 ppm of lithium.

28. A method for separating magnesium from a primary aqueous solution, comprising:
contacting the primary aqueous solution with an initial organic liquid phase composition in a primary extraction stage to form a first mixture, wherein the initial organic phase composition comprises a hydroxamic acid;
separating the first mixture to obtain a metal-reduced raffinate and a metal-containing organic phase;
contacting the metal-reduced raffinate with a secondary organic phase composition in a secondary extraction stage to form a second mixture, wherein the secondary organic phase composition comprises a hydroxamic acid;
maintaining the pH of the second mixture at a pH of about 5 to about 12;
separating the second mixture to obtain a magnesium-depleted raffinate and a magnesium-containing organic phase; and
stripping the magnesium-containing organic phase with an acidic aqueous solution to obtain the magnesium in a magnesium-containing aqueous solution.

29. A method for separating calcium from a primary aqueous solution, comprising:
contacting the primary aqueous solution with an initial organic liquid phase composition in a primary extraction stage to form a first mixture, wherein the initial organic phase composition comprises a hydroxamic acid;
separating the first mixture to obtain a metal-reduced raffinate and a metal-containing organic phase;
contacting the metal-reduced raffinate with a secondary organic phase composition in a secondary extraction stage to form a second mixture, wherein the secondary organic phase composition comprises a hydroxamic acid;
maintaining the pH of the second mixture at a pH of about 5 to about 12;
separating the second mixture to obtain a calcium-depleted raffinate and a calcium-containing organic phase; and
stripping the calcium-containing organic phase with an acidic aqueous solution to obtain the calcium in a calcium-containing aqueous solution.
